(19) United States
(12) Patent Application Publication
(10) Pub. No.: US 2003/0131167 A1
(43) Pub. Date: Jul. 10, 2003

(54) Node ID discovery

(76) Inventors: Linda J. Rankin, Portland, OR (US); Ling Cen, Austin, TX (US)

Correspondence Address: FISH & RICHARDSON, PC, 4350 LA JOLLA VILLAGE DRIVE, SUITE 500, SAN DIEGO, CA, 92122, US

(21) Appl. No.: 10/029,555

(22) Filed: Dec. 20, 2001

(51) Int. Cl. G06F 13/00

(52) U.S. Cl. 710/104

(57) ABSTRACT

A method includes determining the node ID information of a second node device of a multi-node computer system. The method stores the node ID information of the second node device on a storage device located on a first node device of the multi-node computer system. The first node device is connected to the second node device and the second node device includes a storage device containing node ID information for a third node device connected to the second node device.

### TECHNICAL FIELD

This invention relates to node ID discovery.

### BACKGROUND

A personal computer, such as the computer system 10 shown in FIG. 1, typically uses a bus 12 to connect components or nodes 14, such as processor nodes 16, memory nodes 18 and 20, and I/O nodes 22. Because the bus provides only one path for transactions among the nodes, requests by nodes to engage in multiple transactions simultaneously are queued, causing delay in the completion of some transactions.

### DESCRIPTION OF DRAWINGS

FIG. 1 shows a prior art computer system;

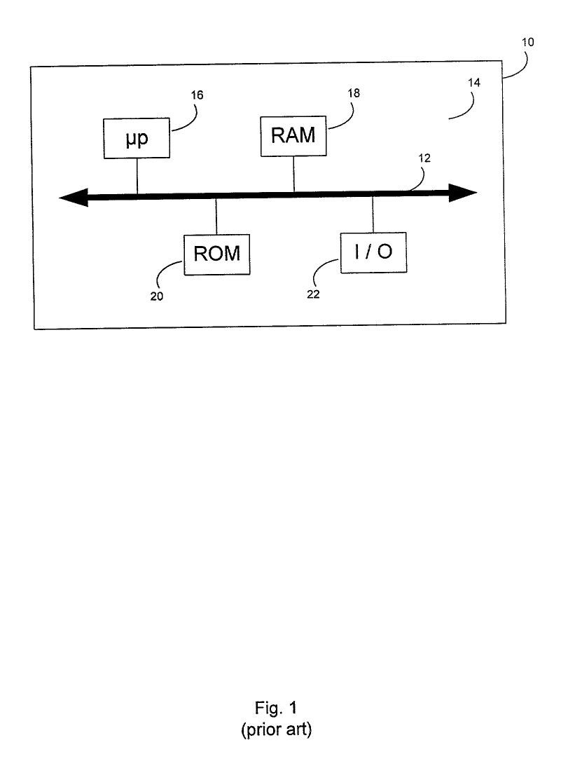

FIG. 2 shows a node ID discovery process;

FIG. 3 shows a more detailed view of a node device;

FIG. 4 shows a node ID discovery method;

FIG. 5 shows another node ID discovery method;

FIG. 6 shows another node ID discovery process; and

FIG. 7 shows another node ID discovery process.

### DETAILED DESCRIPTION

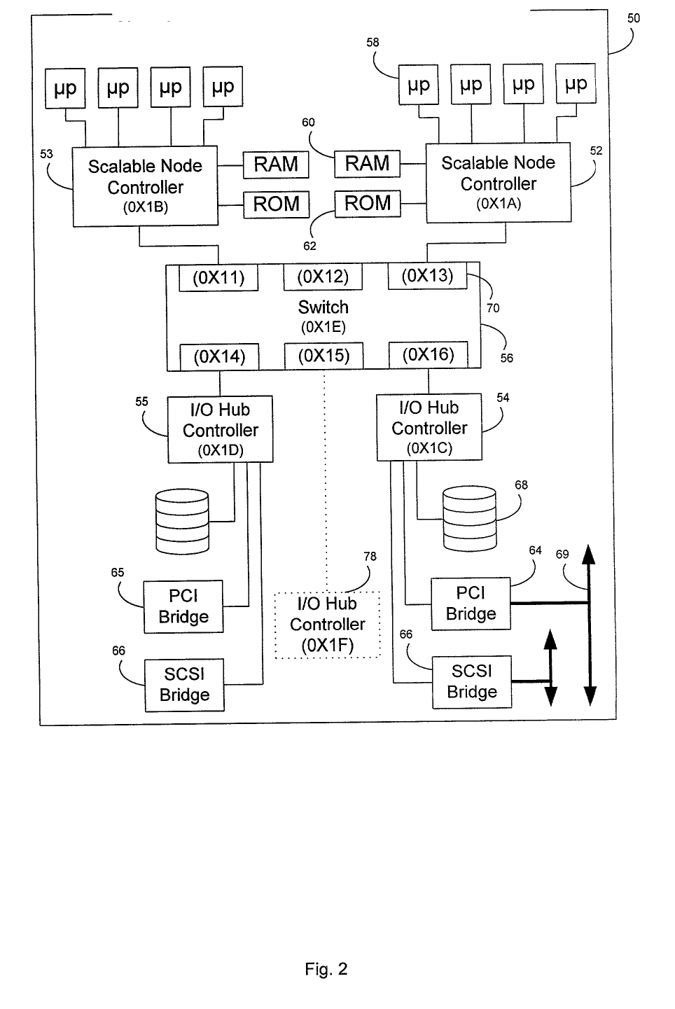

Some computers used as servers and high-end workstations, such as the computer system 50 shown in FIG. 2, do not use a bus for transactions among nodes. Instead, a switch 56 connects the nodes of the system. Examples of these nodes are scalable node controller 52 and I/O hub controller 54. Switch 56 may be a cross bar switch or a router, for example. A switch enables the nodes to dynamically connect over multiple paths, thus reducing latency and allowing large block transfers. To allow for the identification and communication by these node devices, each node device has a unique node ID.

A scalable node controller 52 connects one or more microprocessors 58, system RAM 60, and system ROM 62 to switch 56. An I/O hub controller 54 connects input/output devices, such as peripheral component interconnect (PCI) bridge 64, small computer system interface (SCSI) bridge 66 and hard disks 68 to switch 56. Additionally, system ROM 62 may also be connected to I/O hub controller 54 in addition to (or in substitution for) any ROM connected to scalable node controller 52. Bridges 64 and 66 allow for the interfacing of the computer system 50 (which incorporates switch topology) and a standard communication bus 69, thus allowing a switch-based system to use a standard communication bus to communicate with many card-based peripherals (e.g., video cards, network adapters, modems). As stated above, switch 56 can be, for example, a cross bar switch, a router, or a ______.

Switch 56 typically includes six ports 70 but the actual number of ports will vary depending on the design and complexity of the computer system 50. Ports 70 are used to interconnect the node devices of the system (e.g., scalable node controllers 52 and I/O hub controllers 54), in that each device is connected to a port 70 on switch 56.

In order to allow the nodes of computer system 50 to communicate with each other, each node of the system (e.g., each scalable node controller 52, each I/O hub controller 54, each switch 56) has a unique node ID or address. Accordingly, once properly configured, the addresses of all the nodes are known. Additionally, the path to the nodes are known, as these devices are daisy-chained together in a known configuration. In this particular example, there are five nodes, namely: two scalable node controllers 52 and 53; two I/O hub controllers 54 and 55; and one switch 56. For this particular example, let's assume that these nodes have the following node ID's respectively: 0X1A; 0X1B; 0X1C; 0X1D; and 0X1E. Additionally, each of the six ports 70 of switch 56 has a port ID, namely: 0X11; 0X12; 0X13; 0X14; 0X15; and 0X16.

During use, when a packet of information is transferred from a first node to a second node, the path on which that packet will travel is known. For example, if information is being transferred from hard disk 68 to PCI bridge 65, I/O hub controller 54, which receives the information from hard disk 68, transmits the information to I/O hub controller 55 (i.e., the node to which PCI bridge 65 is attached). This information, which is typically in the form of a packet, is addressed to the node ID 0X1D. When port 0X16 of switch 56 receives this information, as the configuration of system 50 is known, this information is transmitted, through port 0X14, to I/O hub controller 55.

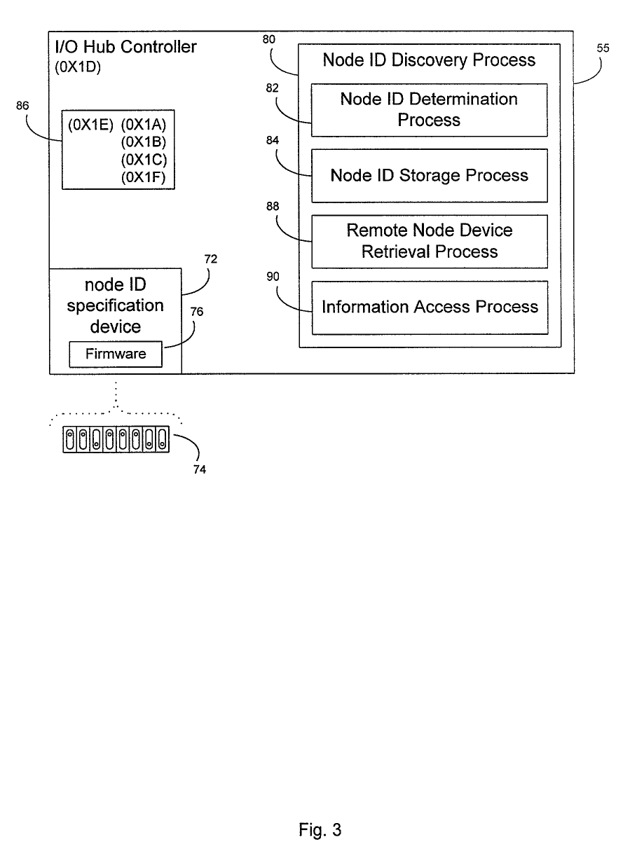

Referring to FIG. 3, a detailed view of an I/O hub controller 54 is shown. The following discussion is applicable to any other node device, such as a switch or a scalable node controller. The node ID assigned to an individual node of the system is specified on a node ID specification device 72 that is built into each node device. This node ID specification device 72 can be a mechanical device such as pin jumpers/DIP switches 74 or a form of electronic firmware 76 (similar to the BIOS setup on a personal computer). If the individual nodes of system 50 are configured using firmware, the user of system 50 would typically configure the node ID's of the system devices using a common configuration utility (not shown).

Since it is desirable to minimize down time in a server environment, it is advantageous to be able to add and remove nodes (i.e., scalable node controllers, switches, I/O hub controllers) while the system is running and operational. Accordingly, the system is typically “hot-swappable”, in that node devices (and the components attached to them) can be added and/or removed while the system is running.

Referring to FIGS. 2 and 3, when the user of system 50 adds a new node device 78 (shown in phantom), the user manually configures the node ID of that new node device using either jumpers/switches 74 or firmware 76. A node ID discovery process 80 then automatically determines the location and routing information of all of the node devices (including new node device 78) in system 50.

This node ID discovery process 80 is present in each node device on system 50 and these multiple node ID discovery processes are simultaneously initiated upon system power-up or node device power-up. Therefore, when a node device is added to system 50, the node ID discovery process in each node device is initiated.

Each node ID discovery process 80 includes a node ID determination process 82 for determining the node ID information (i.e., the node address) of the node devices that are connected to it. For example, if the node device in question is I/O hub controller 55, this node device is only attached to one other node device, namely switch 56 having a node ID of 0X1E. Accordingly, the node ID information obtained would be this node address.

The manner in which this node ID information is obtained can occur in several ways. For example, node ID determination process 82 may directly read the node ID specification device of the remote node device. Alternatively, node ID determination process 82 may request this node ID information from the remote node device and then the remote node device (i.e., the device being polled) may transmit the information to the node device making the request. Further, the remote node device may automatically transmit its node ID information to the node devices to which it is attached. This automatic transmission would occur when node ID discovery process 80 is initialized (e.g., system power-up, node device power-up, and so forth). Node ID determination process 82 would then receive this transmitted node ID information, thus determining the node ID information of the device(s) to which it is attached.

A node ID storage process 84 stores this node ID information (namely address 0X1E) concerning the attached node device (namely switch 56) on a storage device 86 located on I/O hub controller 55. Therefore, once node ID storage process 84 completes execution, storage device 86 will include a list of node addresses concerning the node devices directly attached to I/O hub controller 55. If I/O hub controller 55 is connected to more than one node device, storage device 86 would contain more than one node address. Storage device 86 may be any standard memory device, such as: random access memory (RAM), programmable read only memory (PROM); electronically-erasable programmable read only memory (EEPROM); etc.

Since each node device in system 50 includes a node ID discovery process 80 and these processes all execute simultaneously, upon completion of the execution of node ID storage process 84, the storage device 86 in each node device contains a list of node addresses for the node devices directly attached to the node device in question. Continuing with the above-stated example, after execution of node ID storage process 84, the content of each storage device 86 incorporated into each node device in system 50 would be as follows:

| Node Device/Device Address | | Content of Storage Device |
|---|---|---|
| Scalable Node Controller | 0X1A | 0X1E |
| Scalable Node Controller | 0X1B | 0X1E |
| I/O Hub Controller | 0X1C | 0X1E |
| I/O Hub Controller | 0X1D | 0X1E |
| Switch | 0X1E | 0X1A, 0X1B, 0X1C, 0X1D, and |
| | | 0X1F |
| Scalable Node Controller | 0X1F | 0X1E |

Continuing with the above-stated example, after the node ID storage process 84 running on I/O hub controller 55 has finished execution, storage device 86 knows the address of the single node device attached to it (i.e., switch 56). Further, as switch 56 was simultaneously running its own version of the node ID discovery process 80, the storage device 86 incorporated into switch 56 will include a list of the node addresses of the node devices attached to it, namely: 0X1A; 0X1B; 0X1C; 0X1D; and 0X1F.

Node ID discovery process 80 includes a remote node device retrieval process 88 for retrieving from the storage device of switch 56 (or whatever node device is actually attached), the content of that node device's storage device. Therefore, I/O hub controller 55 will retrieve from switch 56 the list of node addresses for the devices attached to switch 56. This retrieved list is then stored on storage device 86 of I/O hub controller 55. This information would be stored in a fashion that specifies that these are the addresses (0X1A; 0X1B; 0X1C; 0X1D; and 0X1F) of the node devices attached to node device 0X1E (i.e., switch 56).

Now that node ID discovery process 80 knows the addresses (i.e., 0X1A; 0X1B; 0X1C; 0X1D; and 0X1F) of the devices attached to switch 56, node ID discovery process 80 will review this list and disregard node device 0X1D (I/O hub controller 55), as this is the node device on which Node ID discovery process 80 is running. Remote node device retrieval process 88 then accesses the storage device of each of the remaining node devices on the list, namely scalable node controller 52, scalable node controller 53, I/O hub controller 54, and I/O hub controller 78 to determine what devices are attached to each of these devices.

Node ID discovery process 80 includes an information access process 90 that allows the remote node retrieval process 88 of a first node device to access and retrieve the information stored on the storage device of a second node device. This information is then stored on storage device 86 by node ID storage process 84. This process of retrieving a list of addresses of attached devices, storing the results, contacting those attached devices to get a list of addresses of the devices attached to them, storing the results, contacting those attached devices to get a list of addresses of the devices attached to them, storing the results, and so forth, is continuously repeated until it is determined that there are no additional devices in the system 50. This results in storage device 86 contain a tree-like list that shows the interconnection of the devices attached to I/O hub controller 55. Accordingly, the information contained in storage device 86 would indicate the following:

| | is attached to | which is attached | which is attached |
|---|---|---|---|
| This device | this device | to these devices | to this device |
| 0X1D | 0X1E | 0X1A | none |
| | | 0X1B | none |
| | | 0X1C | none |
| | | 0X1F | none |

Therefore, it is clear from the above table that in order for any piece of information to be transferred within system 50, switch 56 (node address 0X1E) must be used. Therefore, this table includes all the necessary routing information required to route a data packet from I/O hub controller 55 (node address 0X1D) to any other node address in system 50. Additionally, since each node device included in system 50 includes a node ID discovery process 80, after execution of the required number of iterations of the remote node device retrieval process 88, each node device will have a routing table specifying that device's routing information.

While node ID discovery process 80 is described above as a process which resides and is executed on the individual node devices of system 50, this is not intended to be a limitation of the invention. Specifically, the node ID discovery processes 80 of all node devices in system 50 may reside and be executed on a common node (such as scalable node controller 53).

Additionally, one or more of the individual processes 82, 84, 88, and 90 of node ID discovery process 80 may reside and be executed on separate node devices. For example, for I/O hub controller 55, the remote node device retrieval process 88 and information access process 90 associated with this device may reside and be executed on scalable node controller 53. However, the node ID determination process 82 and node ID storage process 84 may reside and be executed on I/O hub controller 55. Additionally, while storage device 86 is described above as being dedicated memory located within a node device, storage device 86 can actual be a portion of system RAM 60.

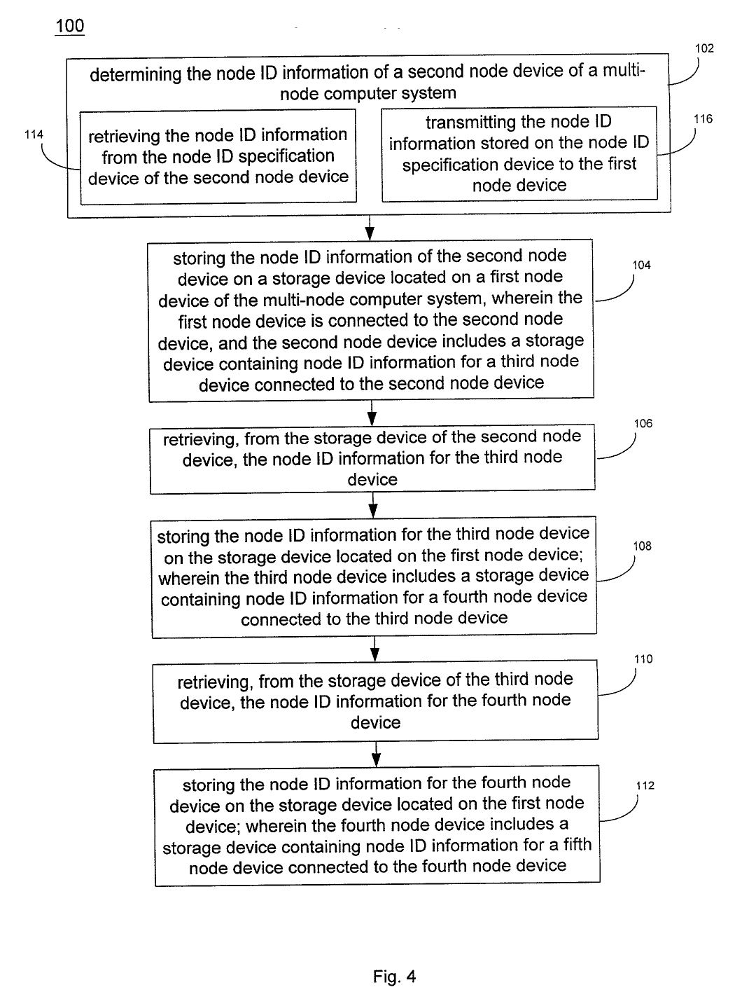

Referring to FIG. 4, there is shown a node ID discovery method 100. Method 100 determines 102 the node ID information of a second node device of a multi-node computer system and stores 104 the node ID information of the second node device on a storage device located on a first node device of the multi-node computer system. The first node device is connected to the second node device. The second node device includes a storage device containing node ID information for a third node device connected to the second node device.

Method 100 retrieves 106, from the storage device of the second node device, the node ID information for the third node device. Method 100 stores 108 the node ID information for the third node device on the storage device located on the first node device. The third node device includes a storage device containing node ID information for a fourth node device connected to the third node device.

Method 100 retrieves 110, from the storage device of the third node device, the node ID information for the fourth node device. Method 100 includes storing 112 the node ID information for the fourth node device on the storage device located on the first node device. The fourth node device includes a storage device containing node ID information for a fifth node device connected to the fourth node device.

Determining 102 the node ID information includes retrieving 114 the node ID information from the node ID specification device of the second node device, or transmitting 116 the node ID information stored on the node ID specification device to the first node device.

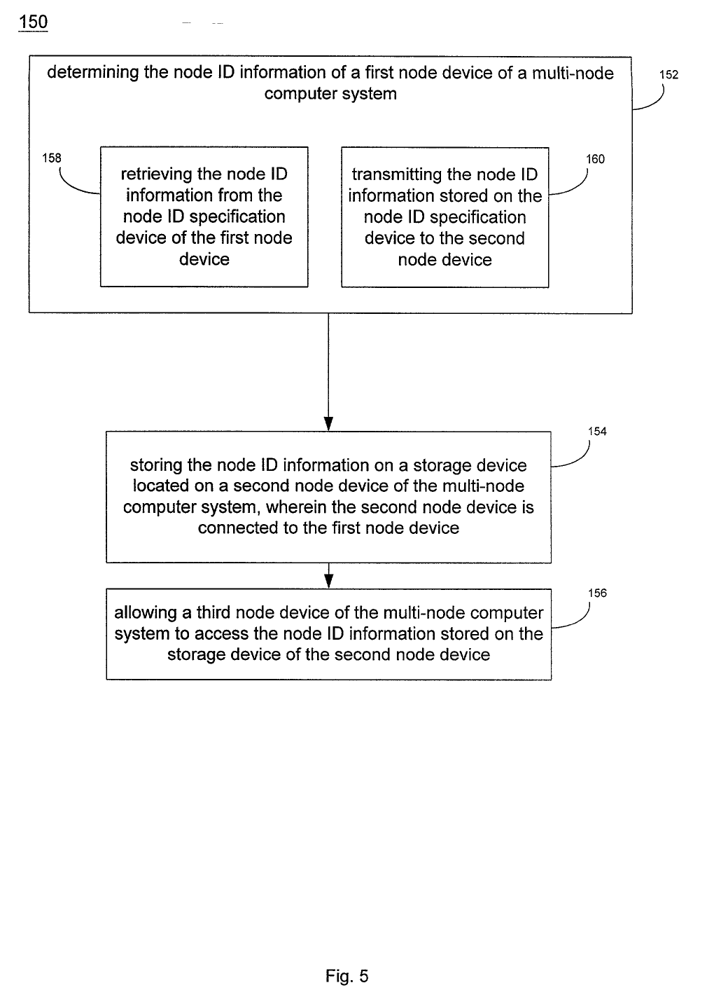

Referring to FIG. 5, there is shown another node ID discovery method 150. Method 150 includes determining 152 the node ID information of a first node device of a multi-node computer system. Method 150 stores 154 the node ID information on a storage device located on a second node device of the multi-node computer system. The second node device is connected to the first node device.

Method 150 includes allowing 156 a third node device of the multi-node computer system to access the node ID information stored on the storage device of the second node device.

Determining 152 the node ID information includes retrieving 158 the node ID information from the node ID specification device of the first node device, or transmitting 160 the node ID information stored on the node ID specification device to the second node device.

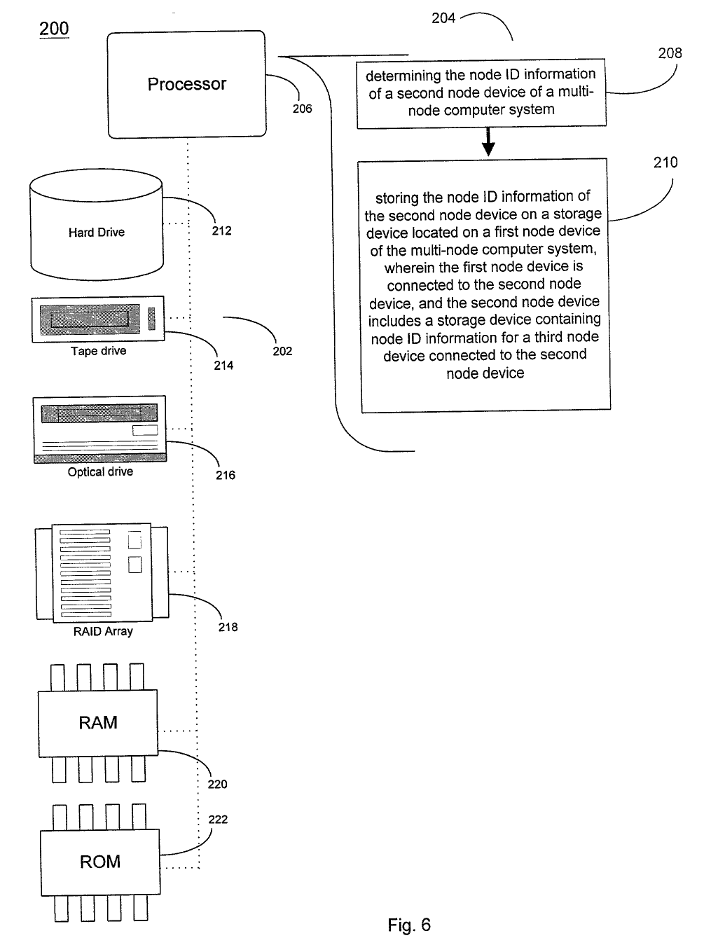

Referring to FIG. 6, there is shown a computer program product 200 that resides on a multi-node computer system. Computer program product 200 includes a computer readable medium 202 for storing instructions 204 which, when executed by a processor 206, cause that processor 206 to determine 208 the node ID information of a second node device of a multi-node computer system. Computer program product 200 stores 210 the node ID information of the second node device on a storage device located on a first node device of the multi-node computer system. The first node device is connected to the second node device. The second node device includes a storage device containing node ID information for a third node device connected to the second node device.

Typical embodiments of computer readable medium 202 are: hard disk drive 212, tape drive 214; optical drive 216; RAID array 218; random access memory 220; and read only memory 222.

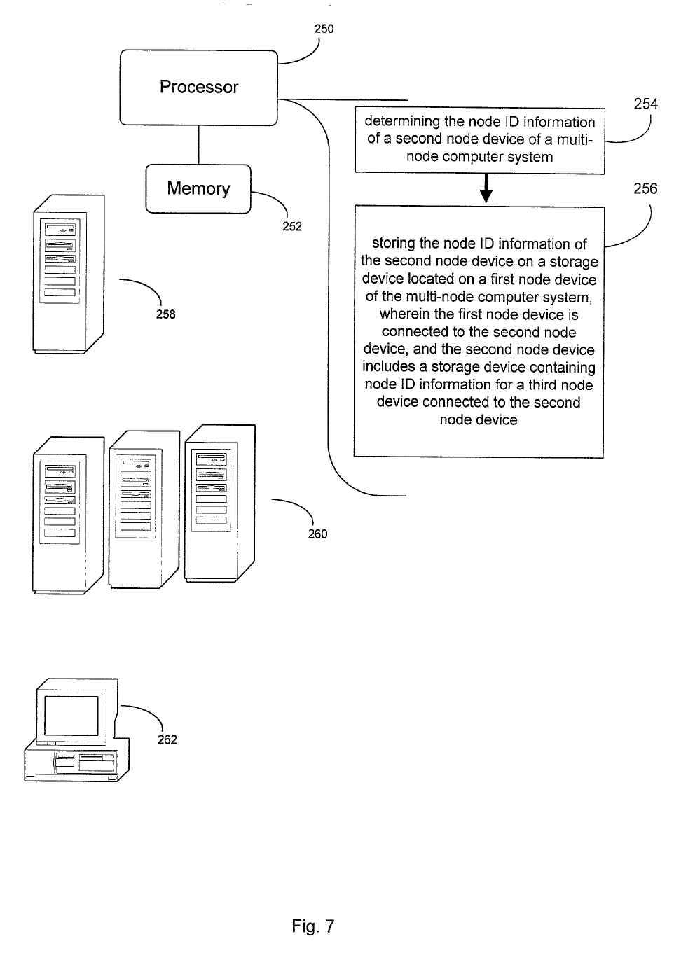

Referring to FIG. 7, there is shown a processor 250 and memory 252 that are configured to determine 254 the node ID information of a second node device of a multi-node computer system. Processor 250 and memory 252 store 256 the node ID information of the second node device on a storage device located on a first node device of the multi-node computer system. The first node device is connected to the second node device. The second node device includes a storage device containing node ID information for a third node device connected to the second node device.

Processor 250 and memory 252 may be incorporated into a network server 258, an array or network servers 260, or a workstation 262.

Other embodiments are within the scope of the following claims.

What is claimed is:

1. A method comprising:
determining the node ID information of a second node device of a multi-node computer system; and
storing the node ID information of the second node device on a storage device located on a first node device of the multi-node computer system;
wherein the first node device is connected to the second node device, and the second node device includes a storage device containing node ID information for a third node device connected to the second node device.

2. The method of claim 1 further comprising:
retrieving, from the storage device of the second node device, the node ID information for the third node device.

3. The method of claim 2 further comprising:
storing the node ID information for the third node device on the storage device located on the first node device;
wherein the third node device includes a storage device containing node ID information for a fourth node device connected to the third node device.

4. The method of claim 3 further comprising:
retrieving, from the storage device of the third node device, the node ID information for the fourth node device.

5. The method of claim 4 further comprising:
storing the node ID information for the fourth node device on the storage device located on the first node device;
wherein the fourth node device includes a storage device containing node ID information for a fifth node device connected to the fourth node device.

6. The method of claim 1 wherein the node ID information is specified on a node ID specification device located on the second node device.

7. The method of claim 6 wherein said determining the node ID information includes retrieving the node ID information from the node ID specification device of the second node device.

8. The method of claim 6 wherein said determining the node ID information includes transmitting the node ID information stored on the node ID specification device to the first node device.

9. A method comprising:
determining node ID information of a first node device of a multi-node computer system; and
storing the node ID information on a storage device located on a second node device of the multi-node computer system, wherein the second node device is connected to the first node device.

10. The method of claim 9 further comprising:
allowing a third node device of the multi-node computer system to access the node ID information stored on the storage device of the second node device.

11. The method of claim 9 wherein the node ID information is specified on a node ID specification device located on the first node device.

12. The method of claim 11 wherein the node ID specification device is one or more jumper pins.

13. The method of claim 11 wherein the node ID specification device is one or more DIP switches.

14. The method of claim 11 wherein the node ID specification device is a read-only memory.

15. The method of claim 11 wherein said determining the node ID information includes retrieving the node ID information from the node ID specification device of the first node device.

16. The method of claim 11 wherein said determining the node ID information includes transmitting the node ID information stored on the node ID specification device to the second node device.

17. A computer program product residing on a computer readable medium having instructions stored thereon which, when executed by the processor, cause that processor to:
determine the node ID information of a second node device of a multi-node computer system; and
store the node ID information of the second node device on a storage device located on a first node device of the multi-node computer system;
wherein the first node device is connected to the second node device, and the second node device includes a storage device containing node ID information for a third node device connected to the second node device.

18. The computer program product of claim 17 wherein said computer readable medium is a read-only memory.

19. The computer program product of claim 17 wherein said computer readable medium is a hard disk drive.

20. A processor and memory configured to:
determine the node ID information of a second node device of a multi-node computer system; and
store said node ID information of said second node device on a storage device located on a first node device of said multi-node computer system;
wherein said first node device is connected to said second node device, and said second node device includes a storage device containing node ID information for a third node device connected to said second node device.

21. The processor and memory of claim 20 wherein said processor and memory are incorporated into a network server.

22. The processor and memory of claim 20 wherein said processor and memory are incorporated into a workstation.

23. A node ID discovery process comprising:
a node ID determination process for determining the node ID information of a second node device of a multi-node computer system; and
a node ID storage process for storing said node ID information of said second node device on a storage device located on a first node device of said multi-node computer system;
wherein said first node device is connected to said second node device, and said second node device includes a storage device containing node ID information for a third node device connected to said second node device.

24. The node ID discovery process of claim 23 further comprising:
a remote node device retrieval process for retrieving, from said storage device of said second node device, said node ID information for said third node device;
wherein said node ID storage process stores said node ID information for said third node device on said storage device located on said first node device.

25. A node ID discovery process comprising:
a node ID determination process for determining the node ID information of a first node device of a multi-node computer system; and
a node ID storage process for storing said node ID information on a storage device located on a second node device of said multi-node computer system;
wherein said second node device is connected to said first node device.

26. The node ID discovery process of claim 25 further comprising:
an information access process for allowing a third node device of said multi-node computer system to access said node ID information stored on said storage device of said second node device.

27. A node ID discovery system comprising:
a multi-port switch containing a plurality of ports;
a I/O hub controller connected to one of said ports;
a scalable node controller connected to one of said ports;
at least one microprocessor connected to said scalable node controller;
a node ID determination process for determining the node ID information of said multi-port switch; and
a node ID storage process for storing said node ID information of said multi-port switch on a storage device located on said scalable node controller;
wherein said multi-port switch includes a storage device containing node ID information for said I/O hub controller.

28. The node ID discovery system of claim 27 further comprising:
a remote node device retrieval process for retrieving, from said storage device of said multi-port switch, said node ID information for said I/O hub controller;
wherein said node ID storage process stores said node ID information for said I/O hub controller on said storage device located on said scalable node controller.

29. A node ID discovery system comprising:
a multi-port switch containing a plurality of ports;
a I/O hub controller connected to one of said ports;
a scalable node controller connected to one of said ports;
at least one microprocessor connected to said scalable node controller;
a node ID determination process for determining the node ID information of said I/O hub controller; and
a node ID storage process for storing said node ID information of said I/O hub controller on a storage device located on said multi-port switch.

30. The node ID discovery system of claim 29 further comprising:
an information access process for allowing a scalable node controller to access said node ID information stored on said storage device of said multi-port switch.
